(19) United States
(12) Patent Application Publication
(10) Pub. No.: US 2025/0143287 A1
(43) Pub. Date: May 8, 2025

(54) SYSTEM AND METHOD FOR OXYGENATION OF FLUSH/STORAGE SOLUTION

(71) Applicant: DEKA Products Limited Partnership, Manchester, NH (US)

(72) Inventors: Joshua Filgate, Lyndeborough, NH (US); David W. Song, Acton, MA (US)

(21) Appl. No.: 18/923,120

(22) Filed: Oct. 22, 2024

Related U.S. Application Data
(60) Provisional application No. 63/547,445, filed on Nov. 6, 2023.

(51) Int. Cl. A01N 1/02

(52) U.S. Cl. CPC A01N 1/122; A01N 1/143; A01N 1/144; A01N 1/162

(57) ABSTRACT

A system and method for pumping fluid through an organ donors organs while monitoring the fluid and organs. A pump is configured to pump fluid from a fluid reservoir through an oxygenator that oxygenates the fluid, a heat exchanger that regulates the temperature of the fluid, and into an organ donors circulatory system or a severed organ. At least one sensor array is coupled to the system to monitor the fluid and organ/s. The fluid pumped through the system is blood or flushing fluid, and the two can be used one at a time. The information gathered by the at least one sensor array is used to inform the system to make changes to increase the organ's likelihood of successful transplant.

### CROSS REFERENCE TO RELATED APPLICATIONS

This application claims priority from U.S. Prov. App. 63/547,445, filed Nov. 6, 2023 (AA892P),

The contents of which are incorporated herein by reference.

### BACKGROUND

The present disclosure relates to a method and system for perfusing a donor organ in the organ transport and storage process. More specifically, the present disclosure relates to a method and system for oxygenated hypothermic perfusion of organs prior to transport and storage and normothermic regional perfusion of organs prior to transport and storage.

The current state of the art for retrieving organs generally involves flushing each organ with a preservation solution to drain the organs of blood then placing them on ice for transport. With organ transplants, timing is imperative, as the longer the period between retrieval and transplant, the higher the chance of decreased graft function and/or loss of organ viability. Generally, livers can be preserved between 12-18 hours; a pancreas can be preserved 8-12 hours; intestines can be preserved approximately 8 hours; and kidneys can be preserved 24-48 hours. The current practice where organs are flushed and placed on ice leaves too many variables open, the flush can be harsh on the organ as it is uncontrolled and the organ is not monitored. The preservation time of organs can see an increase as systems and methods for organ transplants are innovated and improved upon. This is important, methods that increase the time to allocate organs can work to decrease the discard rates of organs that are deemed transplantable prior to retrieval.

Since the first kidney was transplanted in 1954, the procedure has not changed greatly despite other major advances in technology and medicine. The current state of care for organ retrieval requires that the organs be blocked from the bodies biological systems and flushed with a cold perfusate. Then the organs are individually removed and preserved in a cold environment for transportation. In the current state of care for organ retrieval, the cold flushing is typically achieved by hanging a bag of preservation solution and letting gravity feed the preservation solution into and through the organs. The cold preservation solution is flushed through the organ immediately before or immediately after removal from the donor. During transport, the cold preservation solution remains in the vasculature of the organ, however, cold preservation solution is not used for continuous perfusion. Flushing the organ with cold preservation solution lowers the metabolic activity of the organ, removes blood from the organ, and primes the organ with the perfusate that is used for subsequent cold storage. These effects on the organ are done with the intention of preserving the organ for as long as possible without damaging the organ. Both warm ischemia and cold ischemia are common occurrences in organs awaiting transplant that lead to damaged organs. The current state of care for organ retrieval experiences conflict, being that the organ does not cool instantly and subsequently, the metabolic processes do not cool and slow instantly. The use of cold flush early on in the retrieval process has thus far been heavily implemented, however, further studies have been conducted that show preference for cold flush being conducted many hours into the retrieval process, after the organ has been subjected to cold storage and machine perfusion.

With the risks associated with organ transplants, new methods have been studied to increase the likelihood of success in organ transplants. Oxygenated hypothermic perfusion is one of those methods being studied. Oxygenated hypothermic perfusion has been studied as a method of reducing some of the deleterious effects of organ storage and transport, such as ischemia. Oxygenated hypothermic machine perfusion (HMP) of retrieved kidneys has been shown to improve renal flow and early graft function. Oxygenated HMP involves perfusing an organ with an oxygenated cold preservation solution. This is different than a typical cold flush which occurs without a machine and is not typically continuous. The continuous perfusion seen in oxygenated HMP works to remove any buildup within the organ's vessels.

Non oxygenated HMP has existed for several years and has been seen as a viable alternative to static cold storage (SCS) that improves organ function and better avoids damage. Oxygenated HMP is more of a recent introduction to organ retrieval, and because many trials on this procedure have only begun within the past decade, there is a lack of procedure or high level standards to follow for oxygenated HMP.

Another method of organ retrieving being studied is normothermic regional perfusion (NRP), where organ perfusion is maintained in situ, in a donor after circulatory death (DCD). NRP has been shown to improve DCD organ recovery by maintaining perfusion to reduce the effect of ischemia, allowing for rehabilitation of organs at the cellular level, and by pumping oxygenated blood through the organs. This allows the organ to be assessed under non-ischemic conditions, along with the organ's response to reperfusion.

Similar to oxygenated HMP the state of art does not have any hard set rules and regulations to follow when performing NRP on a DCD. One accepted procedure of NRP (Mayo Clinic Procedure) details the amount of time surgeons must wait between certain points in the organ retrieval process. This includes waiting up to 27 minutes from when the systolic arterial pressure drops below 50 mmHg, then after 5 minutes the organ retrieval process can begin. Next, one of the two types of NRP begins. A-NRP, which includes the perfusion of abdominal organs, and TA-NRP, which includes the perfusion of thoracic organs. A-NRP begins by cannulating the femoral artery and vein or abdominal aorta and inferior vena cava, and then attaching a VA-ECMO circuit. As it stands, this process does not have a standard as far as setting up the components for the NRP, which typically includes, cannulas, pumps, an oxygenator and a source of perfusate.

What is needed is a system to be used prior to retrieval, after retrieval, and/or during transport, where the device can facilitate a controlled cold flush through an organ, improving graft function. What is needed is a controlled and monitored cold flush system that improves the quality of an incoming organ, organ performance on maintenance/transport systems, and improves graft functions in patients and reduce graft injury. What is needed is an oxygenated HMP system that improves the quality of an incoming organ, organ performance on maintenance/transport systems, and improves graft functions in patients and reduce graft injury. What is needed is an NRP system to be used prior to organ transport, where the device can facilitate a more controlled reperfusion through an organ, improving graft function. What is needed is an NRP system that improves the quality of an incoming organ, organ performance on maintenance/transport systems, and improves graft functions in patients. What is needed is an NRP system which monitors perfusion and the state of the organ. What is needed is a system capable of performing NRP and cold flush to be used prior to and/or during transport, where the device can reperfuse organs and then flush the organs with a saline or a cold preservation solution. What is needed is a system capable of performing NRP and oxygenated HMP that improves the quality of an incoming organ, organ performance on maintenance/transport systems, and improves graft functions in patients. What is needed is a system capable of performing NRP and cold flush that monitors perfusion and collects data on organ performance/health.

### SUMMARY

In accordance with some configurations, the present disclosure provides most generally a method and system for perfusing an organ during the organ transport and storage process. In one embodiment, a pump is provided that is configured to pump a fluid through the system. The pump is fluidly coupled to at least one other element of the system. In the system, a fluid reservoir is provided to store the fluid. The fluid reservoir is fluidly coupled to at least one other element of the system. In the system, an oxygenator is provided to oxygenate the fluid. The oxygenator is coupled to at least one other element of the system. In the system, a heat exchanger is provided to control the temperature of the fluid. The heat exchanger is coupled to at least one other element of the system. In the system, a controller is provided to control various aspects of the system based on variables recorded by at least one sensor. In an aspect, the system is cannulated to an artery and a vein of an organ donor or an individual organ. In an aspect, the pump provides a flow of the fluid that flows through the system and through the organ donor/organ.

In one configuration, a pump, pumps fluid from the fluid reservoir and through the organ donor/organ. In an aspect, the fluid may be a preservation solution. Prior to being pumped through the organ donor/organ, the preservation solution may pass through the oxygenator to be oxygenated and/or pass through the heat exchanger to be cooled/warmed. In an aspect, the preservation solution passes through the organ donor/organ and is collected in a waste receptacle. In another aspect, the preservation solution passes through the organ donor/organ and is recycled back through the system.

In another configuration, the present disclosure teaches a method and system that controls fluid flow. In an aspect, the flow of the fluid through the system and through the organ donor/organ is monitored and controlled. In an aspect, the system provides a flow controller for controlling the flow of fluid. In an aspect, the system provides at least one flow sensor to sense characteristics of the flow. The flow controller is configured to adjust or maintain the flow of the fluid based on the characteristics being sensed by the at least one flow sensor. Characteristics to be sensed may include, but are not limited to; flow rate, and end of stroke. In an aspect, the flow rate can be manually determined based on data accepted in the field of art. In an aspect, the at least one flow sensor is positioned on the system before the fluid flows through the organ donor/organ. In an aspect, the at least one flow sensor is positioned on the system after the fluid flows through the organ donor/organ.

In a further configuration, the present disclosure teaches a method and system that oxygenates fluid before passing through an organ donor/organ. In an aspect, an oxygenator is coupled to at least one element of the system through which the fluid flows. The oxygenator oxygenates the fluid prior to the fluid being pumped through the organ donor/organ. In an aspect, the oxygenation of the fluid is controlled by a controller. In an aspect, the controller adjusts or maintains the level of oxygenation based on information gathered by at least one oxygen sensor that monitors the oxygenation of the fluid. In an aspect, the at least one oxygen sensor measures various characteristics of the fluid. Characteristics to be sensed may include, but are not limited to; oxygen concentration, and partial pressure of oxygen. In an aspect, the oxygenation of the fluid can be manually input based on data accepted in the field of art. In an aspect, the at least one oxygen sensor is positioned on the system before the fluid flows through the organ donor/organ. In an aspect, the at least one oxygen sensor is positioned on the system after the fluid flows through the organ donor/organ.

In still a further configuration, the present disclosure teaches a method and system that controls the temperature of fluid before passing through an organ donor/organ. In an aspect, a heat exchanger is coupled to at least one element of the system through which the fluid flows. The heat exchanger changes or maintains the temperature of the fluid. The temperature of the fluid is controlled by a controller. In an aspect, the controller adjusts or maintains the temperature of the fluid based on information gathered by at least one temperature sensor that monitors the temperature of the fluid. In an aspect, the at least one temperature sensor measures various characteristics of the fluid. Characteristics to be sensed may include, but are not limited to fluid temperature. In an aspect, the oxygenation of the fluid can be manually input based on data accepted in the field of art. In an aspect, the at least one temperature sensor is positioned on the system before the fluid flows through the organ donor/organ. In an aspect, the at least one temperature is positioned on the system after the fluid flows through the organ donor/organ.

In yet a further configuration, the present disclosure teaches a method and system that monitors the state of the organ/s. In an aspect, at least one sensor monitors several characteristics of the organ/s. Characteristics to be sensed may include, but are not limited to; temperature of the organ/s, color of the organ/s, blood pressure of the organ/s, metabolic activity of the organ/s, biochemical activity of the organ/s, and other indicators of organ health. In an aspect, these characteristics are used to adjust the fluid flow rate, oxygenation level, and temperature of the fluid.

In some configurations, the system of the present teachings is confined to a housing. In an aspect, the housing keeps all the elements of the system in one confined housing to increase ease of use and mobility. In an aspect, confining the system to a housing allows a user to easily transport and implement the system during an organ recovery. In an aspect, certain elements may be located on the exterior of the housing while some elements may be located within the interior of the housing.

In some configurations, a method of the present teachings includes cannulating at least one tissue of an organ donor/organ. In an aspect, the organ donor/organ is flushed of blood. In an aspect, the method of the present teachings includes pumping a preservation solution through the organ donor/organ. In an aspect, the method of the present teachings includes oxygenating the preservation solution before pumping it through the organ donor/organ. In an aspect, the method of the present teachings includes lowering the temperature of the preservation solution before pumping it through the organ donor/organ. In an aspect, the method of the present teachings includes both oxygenating and cooling the preservation solution before pumping it through the organ donor/organ. In an aspect, the oxygenated and/or cooled preservation solution is pumped through the organ donor/organ and collected in a waste receptacle. In another aspect, the oxygenated and/or cooled preservation solution is recycled through the organ donor/organ. In an aspect, the organ donor/organ is monitored and the flow rate and temperature of the preservation solution is adjusted according to the results of monitoring the organ donor/organ.

In another embodiment, the present disclosure provides a system for perfusing and monitoring an organ donor/organ in the organ recovery process. In an aspect, the fluid is blood, and the blood is pumped through the system and the organ donor/organ continuously to simulate bodily blood flow. Prior to being pumped through the organ donor/organ, the blood may pass through the oxygenator to be oxygenated and/or pass through the heat exchanger to be cooled/warmed. In an aspect, the blood passes through the organ donor/organ and is collected is a waste receptacle. In another aspect, the preservation solution passes through the organ donor/organ and is recycled back through the system. In an aspect, a controller regulates and adjusts the flow of the blood. In an aspect, the controller regulates and adjusts blood flow based on manual input. In another aspect, the controller regulates and adjusts blood flow based on information gathered by at least one sensor

In some configurations, when the fluid being pumped is blood, information on several characteristics may be monitored by at least one sensor. Characteristics to be monitored include but are not limited to; perfusion quality, pressure, flow, vascular resistance, temperature, oxygen consumption, oxygen concentration, and glucose consumption.

In some configurations, in addition to blood the system may infuse nutrients into the fluid.

In some configurations, a secondary pump may be included in the system. The secondary pump may be an infusion pump and may infuse medicine and/or other nutrients into the fluid.

In some configurations, a method of the present teachings includes cannulating at least one tissue of an organ. In an aspect, the organ is flushed of blood. In an aspect, the method of the present teachings includes pumping blood through the organ. In an aspect, the method of the present teachings includes oxygenating the blood before pumping it through the organ. In an aspect, the method of the present teachings includes controlling the temperature of the blood before pumping it through the organ. In an aspect, the method of the present teachings includes both oxygenating and controlling the temperature of the blood before pumping it through the organ. In an aspect, the oxygenated and/or temperature-controlled blood is pumped through the organ and collected in a waste receptacle. In another aspect, the oxygenated and/or temperature-controlled blood is recycled through the organ. In an aspect, the organ is monitored and the flow rate and temperature of the blood is adjusted according to the results of monitoring the organ.

In another embodiment, the systems and methods of the present teachings includes cannulating an artery of a deceased patient in situ. Having a first fluid reservoir filled with blood, and oxygenating and regulating the temperature of said blood before perfusing the deceased patient's organs. In an aspect, after the deceased patient's organs have been perfused with oxygenated blood, the temperature of the blood may be cooled. In an aspect, the system may transition from perfusing blood to perfusing preservation solution stored in a second fluid reservoir. The transition may be achieved by means of, for example but not limited to, a valve or a controller. In an aspect, the preservation solution is cooled and oxygenated to lower the temperature of the deceased patient's organs. In an aspect, the organs are monitored and the flow rate and temperature of the two fluids is adjusted according to the results of monitoring the organ.

### BRIEF DESCRIPTION OF THE DRAWINGS

The foregoing features of the disclosure will be more readily understood by reference to the following description, taken with reference to the accompanying drawings, in which:

FIGS. 1A-1D depict a system for pumping fluid through an organ donor;

FIG. 2 depicts a system for pumping fluid through an organ donor;

FIGS. 3A-3B depict a system for pumping fluid through an organ donor;

FIG. 4 depicts a method for pumping fluid through an organ donor;

FIG. 5 depicts a method for pumping fluid through an organ donor;

FIG. 6 depicts a method for pumping fluid through an organ donor;

FIG. 7 depicts a method of perfusing and monitoring organs for transplant;

FIGS. 8A-8B depict a system for pumping fluid through an organ donor and organ;

FIG. 9A-9B depicts a depicts a system for pumping fluid through an organ out of the body; FIG. 9C depicts a system for pumping fluid through an organ in situ; and

FIGS. 10A-10B depict a method for pumping fluid through an organ.

### DETAILED DESCRIPTION

The present disclosure teaches a method and system for perfusing an organ in the organ recovery process. Specifically, the system and method of the present teachings is configured to allow for an organ or organs to be continuously perfused while monitoring several characteristics of the flow and organ itself. The system of the present teachings includes, but is not limited to including, a fluid reservoir, a pump, an oxygenator, a controller, and a heat exchanger.

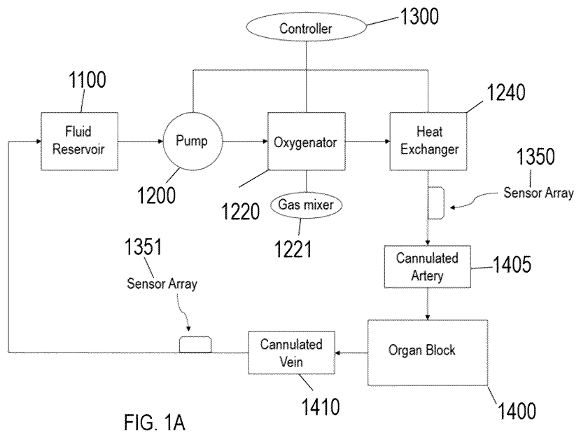

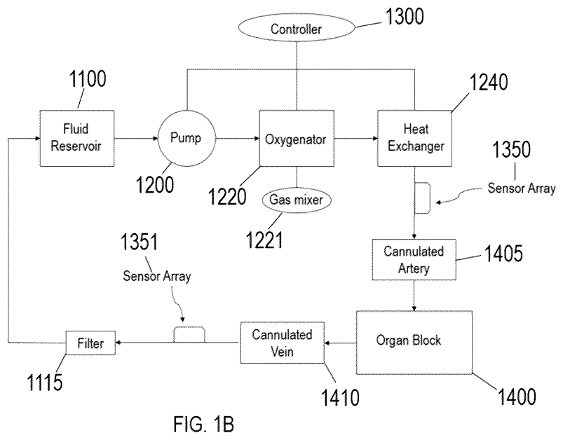

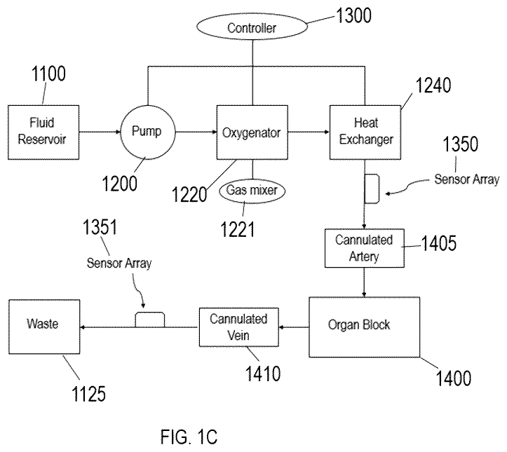

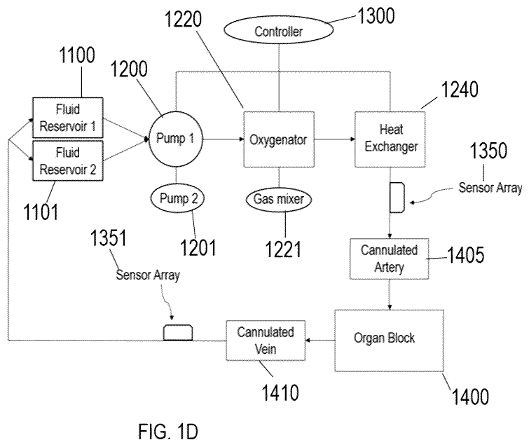

The present disclosure provides, most generally, a method and system for perfusing an organ in the organ recovery process. Referring now to FIGS. 1A-1D. As can be seen in FIGS. 1A-1D, the system 1000 generally includes at least one fluid reservoir 1100, at least one pump 1200, an oxygenator 1220, a heat exchanger 1240, at least one controller 1300, at least one sensor array 1350, and a waste receptacle 1125. The system involves a pump 1200 that pumps fluid from a fluid reservoir 1100 through the elements of the system 1000. In an aspect, the pump 1200 pumps fluid from the fluid reservoir 1100, through the oxygenator 1220, through the heat exchanger 1240, through a cannulated artery 1405, through an organ 1400, and through a cannulated vein 1410. The system 1000 is generally used on an organ donor, where the donor organs are being prepped for removal and transport. Fluid is pumped through the system through a fluid line and is oxygenated by the oxygenator 1220, and thermally regulated by the heat exchanger 1240. The fluid line is representative of the connection between certain elements of the system 1000 to allow fluid to flow through the system 1000. In an aspect, the fluid reservoir is fluidly connected to the pump 1200. In an aspect, the pump 1200 is fluidly connected to the oxygenator 1220. In an aspect, the oxygenator 1220 is fluidly connected to the heat exchanger 1240. In an aspect, the heat exchanger 1240 is fluidly connected to the cannulated artery 1405. In an aspect, the cannulated vein 1410 is fluidly connected to the waste receptacle 1125. Any one element of the system 1000 may be fluidly connected to any other element of the system 1000 in any order and any combination.

Still referring to FIGS. 1A-D, the at least one sensor array may include but is not limited to including; a flow sensor, a temperature sensor, an oxygen sensor, a pressure sensor, and a color sensor. The at least one sensor array 1350 may comprise any combination and any order of the aforementioned sensors and any additional sensors not included. The at least one sensor array 1350 may be placed on any point along the fluid line of the system 1000. A flow sensor is used to monitor the flow of the fluid at any point in the system 1000. A temperature sensor is used to monitor the temperature of the fluid at any point in the system 1000. A temperature sensor is used to monitor the temperature of the organ in the system 1000. An oxygen sensor is used to monitor the oxygen levels of the fluid at any point in the system 1000. A pressure sensor is used to monitor the pressure of the fluid flow at any point in the system 1000. A color sensor is used to monitor the color of the organ in the system 1000. In an aspect, the at least one sensor array 1350 is positioned along the fluid line at a point prior to the fluid's entry into the cannulated artery 1405. In an aspect, the at least one sensor array 1350 is positioned along the fluid line at a point after the fluid's exiting of the cannulated vein 1410. In an aspect, the at least one sensor array 1350 is communicatively coupled to the at least one controller 1300. In an aspect, the information gathered by the at least one sensor array 1350 is passed to the at least one controller 1300. In an aspect, the information passed to the at least one controller 1300 is used to modify instructions from the at least one controller 1300.

Still referring to FIGS. 1A-D, the at least one controller 1300 may be for example, but not limited to, a thermal controller, a flow controller, an oxygenation controller, and a pressure controller. One of the at least one controllers 1300 is communicatively coupled to the pump 1200 to facilitate the pumping of the fluid. One of the least one controllers 1300 is communicatively coupled to the oxygenator 1220 and gas mixer 1221 to facilitate oxygenation of the fluid. The gas mixer provides at least one type of gas to the oxygenator, types of gases may include but are not limited to including; oxygen, nitrogen, and carbon dioxide. One of the at least one controllers 1300 is communicatively coupled to the heat exchanger 1240 to facilitate thermal regulation of the fluid. One of the at least one controllers 1300 is communicatively coupled to the pump 1200 to facilitate the flow of the fluid.

Still referring to FIGS. 1A-D, in an aspect, the fluid being pumped through the system 1000 is a flushing fluid, the flushing fluid may be, for example but not limited to, saline, saline based solutions, albumin based solutions, preservation solution, crystalloid solutions, colloid solutions, or lactated ringer solution. The preservation solution may be any of the accepted preservation solutions used by the medical field in the processes of organ preservation, for example but not limited to, UW solution, and HTK solution. When pumping flushing fluid through the system 1000 certain nutrients and antibiotics may be added to the solution, nutrients may be for example, but not limited to, glucose. The flushing fluid is pumped through the system 1000 and emptied into a waste receptacle 1125. Flushing fluid may be oxygenated by the oxygenator 1220. Preservation may be cooled by the heat exchanger 1240. The oxygenated and/or cooled flushing fluid is pumped through the system to flush the organs in the organ block of any blood or buildup.

Continuing to refer to FIGS. 1A-D, in another aspect, the fluid may be blood. The blood may be the organ donor's own blood or donor blood. When pumping blood through the system 1000 certain nutrients, antibiotics, and compounds may be added to the solution, for example, but not limited to the example, heparin may be added to the blood. Pumping blood through the system 1000 replaces and replicates the body's natural blood flow as a way to preserve and maintain organ health during the organ recovery process. While passing through the system 1000, the blood may be oxygenated by the oxygenator 1220. The blood may be thermally regulated by the heat exchanger 1240. The blood can pass through the system 1000 passing through the organ block 1400 and out of the cannulated vein 1410, it may then cycle back to the fluid reservoir 1100 so it may continue to cycle through the system 1000 and blood will not have to be continuously provided to the system 1000. When the blood passes back through the system it may pass through a filter 1115 along the fluid line. The filter may filter 1115 out any clots, metabolites or similar buildups. The filter 1115 may be for example, but not limited to, an arterial filter, or a mesh filter.

Referring specifically to FIG. 1C which illustrates the system 1000 as having two optional pathways (dotted lines) after passing through the organ block 1400 and out the cannulated vein 1410. In an aspect fluid can be pumped through the system 1000 and recycle back into the fluid reservoir 1100. Before the fluid recycles back into the fluid reservoir 1100 it can pass through a filter. If fluid does not recycle back into the fluid reservoir 1100 it empties into a waste receptacle 1125. When the fluid is blood, it will typically recycle back into the fluid reservoir 1100, it may first pass through a filter 1115 as well. When the fluid is flushing fluid it will typically empty into a waste receptacle 1125. In an aspect, the fluid reservoir 1100 first be filled with blood, and the blood is pumped through the system 1000. Then the blood in the fluid reservoir 1100 may be replaced with flushing fluid which will then be pumped through the system 1000. In another aspect, the system has a fluid reservoir 1100 capable of storing two different fluids.

Referring specifically to FIG. 1D, a secondary pump may also be included in the system. A secondary pump can be an infusion pump. Wherein the infusion pump can infuse various medicines and nutrients into the fluid, for example, but not limited to, vasodilators, glucose, antibiotics, and anticoagulants. A second fluid reservoir may also be included in the system, where one fluid reservoir may be configured to contain blood and the second fluid reservoir is configured to contain flushing fluid. In the first perfusion stage where blood is being pumped through the organ donor, there is a transition period where the temperature of the blood may be lowered prior to switching to a perfusion of flushing fluid. When the transition to the second perfusion stage where flushing fluid is utilized, the first fluid reservoir containing blood is stopped from releasing blood into the system and the second fluid reservoir containing flushing fluid is activated to release flushing fluid into the system.

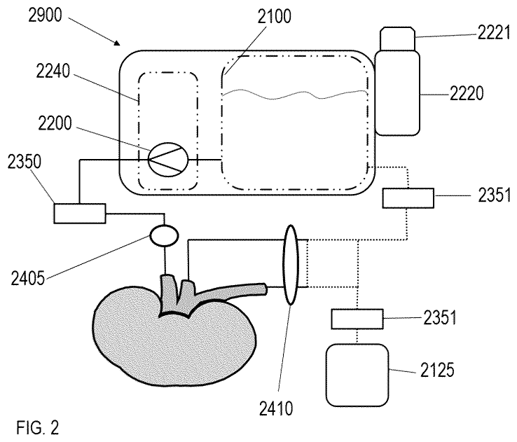

Referring now to FIG. 2, which illustrates the system 2000 functioning with a kidney in situ, and the elements of the system 2000 being set in a housing 9900. The system is not limited to the kidney, the system may also integrate with for example, but not limited to, the liver, the intestines, the heart, the entire block of abdominal organs, the entire block of thoracic organs, and all other combinations and individual organs located in the human body. The system 2000 generally includes a fluid reservoir 2100, a pump 2200, an oxygenator 2220, a heat exchanger 2240, at least one controller 2300, at least one sensor array 2350, and a waste receptacle 2125. As a part of the system 2000, an artery and a vein are cannulated 2405, 2410. These cannulations allow the system to perfuse fluid through the donor. For example, in NRP, blood will be pumped through the system 2000 and into a donor, the blood will perfuse the donor's organs and then be pumped out of the donor and back into the system to be recycled through or emptied into a waste receptacle 2125.

Still referring to FIG. 2, when the fluid being pumped through the system 2000 is blood, the intent is typically to replicate the body's natural blood flow to give organs the best chance at survival and transplant success. The system 2000 replaces the function of the heart pumping blood by artificially pumping blood through the system 2000 by way of the pump 2200. This will extend the life of the organs by continuously supplying the organs with blood and oxygen. This is especially helpful in an organ transplant where not all of the organs are removed at the same time. For example, kidneys which are typically the last of the organs to be removed in an organ retrieval should benefit from this perfusion. Rather than flushing all of the organs and retrieving them one by one, using the system 2000 to perfuse the organs with oxygenated blood will continue to provide the organs, like the kidneys, that are retrieved later in the process with the elements essential to further avoid or delay ischemia. As the organ retrieving process continues, the temperature of the blood and oxygen concentration can be lowered to transition the organs into a stage where they are ready for transport.

Still Referring to FIG. 2, the system 2000 can also perfuse a donor's body and organs with flushing fluid. As organs are ready to be retrieved, they are not typically transported full of blood. The process typically involves lowering the temperature of the organs and flushing them. In the system 2000, the fluid be pumped may be transitioned from blood to a flushing fluid which can be further cooled to lower the temperature of the organ and decrease its metabolic activity. Transitioning from blood to flushing fluid allows the system 2000 to pump through a cooled flushing fluid that will flush the organs of blood and metabolites while lowering the temperature and metabolic activity of the organs. Flushing fluid may be lowered to a temperature between 0-10 degrees Celsius.

Continuing to refer to FIG. 2, the system 2000 has several potential pathways for fluid and waste. One potential pathway involves pumping fluid through the system 2000 and into a donor's body, the fluid may then pass out through the cannulated vein 2410 and into a waste receptacle 2125 or recycle back into the fluid reservoir 2100. When the fluid being pumped is blood, it is typically going to be recycled into the fluid reservoir 2100, where it may or may not pass through a filter. When the fluid being pumped is flushing fluid, it is typically going to empty into a waste receptacle 2125. The fluid being pumped through the system 2000 may not be the only fluid involved in the system 2000. Kidney, for example, produce urine. The ureter of the kidneys may be fluidly connected to the system 2000 so that it is emptied into the waste receptacle 2125. Because of the different paths of the fluid, sensor arrays 2350 can be placed in several different spots along the system 2000. For example, a sensor array can be placed along the fluid line between the cannulated vein 2410 and the waste receptacle 2125, so that fluid exiting the organs can be monitored. Another placement for the sensor array 2350 may be between the cannulated vein 2410 and the fluid reservoir 2100 so that fluid can be monitored after exiting the organs.

Still referring to FIG. 2, the at least one sensor array 2350, 2351 may include but is not limited to including; a flow sensor, a temperature sensor, an oxygen sensor, a pressure sensor, and a color sensor. The at least one sensor array 2350, 2351 may comprise any combination and any order of the aforementioned sensors and any additional sensors not included. The at least one sensor array 2350 may be placed on any point along the fluid line of the system 2000. A flow sensor is used to monitor the flow of the fluid at any point in the system 2000. A temperature sensor is used to monitor the temperature of the fluid at any point in the system 2000. A temperature sensor is used to monitor the temperature of the organ in the system 2000. An oxygen sensor is used to monitor the oxygen levels of the fluid at any point in the system 2000. A pressure sensor is used to monitor the pressure of the fluid flow at any point in the system 2000. A color sensor is used to monitor the color of the organ in the system 2000. As the fluid flows through the system and passes through the at least one sensor array 2350, 2351 the sensors within will monitor the fluid for variables. Variables may include, but are not limited to, flow, pressure, oxygen concentration, pressure, and color. These variables are used to regulate the flow of the fluid and monitor the health of the organ. Placing the at least one sensor array 2350, 2351 before and after entry into the organ donor allows for multiple sets of data to be compared to further monitor the health of the organ.

Continuing to refer to FIG. 2, certain elements of the system 2000, for example, but not limited to, the oxygenator 2220, the fluid reservoir 2100, the pump 2200, and the heat exchanger 2240 may be set in a housing 2900. The elements may be interconnected and placed within a larger housing to make the system 2000 more mobile and easier to move around and use in a medical setting. For example, having some or all of the elements of the system 2000 in a housing 2900 makes it so the system 2000 can be quickly and easily transported into operating rooms as necessary. The housing 2900 will keep the elements together and take up less room in an OR.

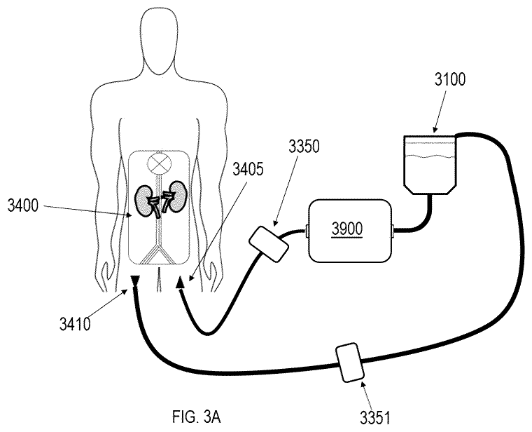

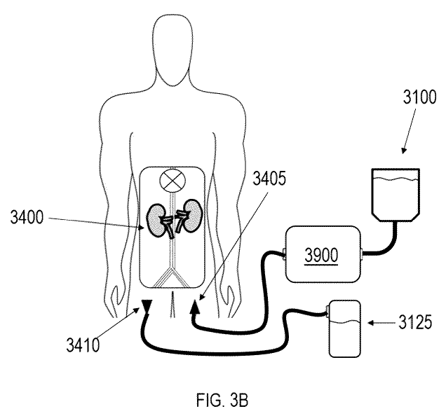

Now referring to FIGS. 3A-3B, which illustrate the system 3000 being connected to an organ donor. The system 3000, as detailed in FIG. 2 may involve a housing 3900 which encloses one or more elements of the system 3000 to increase mobility and ease of use of the system 3000. A housing 3900 may enclose, the pump, the oxygenator, the gas mixer, and the heat exchanger. FIGS. 3A-3B illustrate the fluid reservoir 3100 as not being enclosed in the housing 3900, however, the system 3000 is not limited to this embodiment. The fluid reservoir 3100, and any other element of the system 3000 may be located on the interior of the housing 3900, on the exterior of the housing 3900, or separately and fluidly connected to the system 3000 by any other means and/or order.

Still referring to FIGS. 3A-3B, to perfuse an organ donor 3400 with a fluid, at least two connections must be made with the organ donor 3400. One connection where fluid can enter the body, and one connection where fluid can exit the body, this is typically achieved by cannulating an artery 3405 for flow in and cannulating a vein 3410 for flow out. There are several pairs of arteries and veins that may be cannulated for this system 3000, for example, but not limited to, the femoral artery and femoral vein, and the abdominal aorta and inferior vena cava. FIGS. 3A-3B illustrate a situation where the system 3000 is connected to an organ donor by means of the femoral artery and femoral vein.

Referring specifically to FIG. 3A, which illustrates the system 3000 as pumping fluid through an organ donor 3400 and recycling said fluid. In a situation where fluid is recycled back into the fluid reservoir 3100 to continue through the system 3000, the fluid being pumped is generally blood. The blood being pumped may be blood directly from the organ donor 3400 or donor blood. The blood is pumped from the fluid reservoir and through the elements of the system 3000 that are enclosed in the housing 3900 to be temperature regulated and oxygenated and then pumped through the organ donor 3400. The blood is pumped into the organ donor 3400 through a cannulated artery 3405 which may be the femoral artery. The blood then circulates through the organs and then exits through the cannulated vein 3410 which may be the femoral vein. Also, when such a process occurs, an aortic clamp 3460 is typically placed below the diaphragm when conducting abdominal NRP. At least one sensor array 3350 can be placed along the system 3000 at any point. One such point may be, for example, but not limited to, the point between the housing 3900 and the cannulated artery 3405. Placing a sensor array 3350 at this point allows the fluid to be monitored prior to its entry into the organ donor. Another place that a sensor array 3350 may be placed is between the cannulated vein 3410 and the fluid reservoir 3100. Placing a sensor array 3350 at this point allows the fluid to be monitored after it exits the organ donor 3400 so that the organs may be monitored further.

Referring specifically to FIG. 3B, which illustrates the system 3000 as pumping fluid through an organ donor 3400 and emptying said fluid into a waste receptacle 3125. In a situation where fluid is emptied into a waste receptacle, the fluid being pumped is generally flushing fluid. The flushing fluid may be, for example but not limited to, saline, saline based solutions, albumin based solutions, preservation solution, crystalloid solutions, colloid solutions, or lactated ringer solution. The preservation solution may be any of the accepted preservation solutions used by the medical field in the processes of organ preservation, for example but not limited to, UW solution, and HTK solution. The flushing fluid is pumped from the fluid reservoir 3100 and through the elements of the system 3000 that are enclosed in the housing 3900 to be cooled and oxygenated and then pumped through the organ donor 3400. The flushing fluid is pumped through the organ donor 3400 through a cannulated artery 3405 which may be a femoral artery 3405. The flushing fluid then circulates through the organs, flushing them of blood and metabolites, and then exiting through the cannulated vein 3410 which may be the femoral vein. At least one sensor array 3350 can be placed along the system 3000 at any point. One such point may be, for example, but not limited to, the point between the housing 3900 and the cannulated artery 3405. Placing a sensor array 3350 at this point allows the fluid to be monitored prior to its entry into the organ donor. Another place that a sensor array 3350 may be placed is between the cannulated vein 3410 and the fluid reservoir 3100. Placing a sensor array 3350 at this point allows the fluid to be monitored after it exits the organ donor 3400 so that the organs may be monitored further.

Again referring to FIGS. 3A-3B, during an organ retrieval the system 3000 may be configured to change between the embodiment shown in FIG. 3A to the embodiment shown in FIG. 3B. If blood is being pumped through an organ donor 3400 like the FIG. 3A illustrates, the system 3000 can be switched to the embodiment of FIG. 3B by replacing the blood in the fluid reservoir 3100 with flushing fluid 3104 or switching to an entirely different fluid reservoir 3100 that is filled with flushing fluid. Then the fluid line extending from the cannulated vein 3410 to the fluid reservoir 3100 can be changed to a fluid line extending from the cannulated vein 3410 to a waste receptacle 3125.

Still referring to FIGS. 3A-3B, the at least one sensor array 3350, 3351 may include but is not limited to including; a flow sensor, a temperature sensor, an oxygen sensor, a pressure sensor, and a color sensor. The at least one sensor array 3350, 3351 may comprise any combination and any order of the aforementioned sensors and any additional sensors not included. The at least one sensor array 3350 may be placed on any point along the fluid line of the system 3000. A flow sensor is used to monitor the flow of the fluid at any point in the system 3000. A temperature sensor is used to monitor the temperature of the fluid at any point in the system 3000. A temperature sensor is used to monitor the temperature of the organ in the system 3000. An oxygen sensor is used to monitor the oxygen levels of the fluid at any point in the system 3000. A pressure sensor is used to monitor the pressure of the fluid flow at any point in the system 3000. A color sensor is used to monitor the color of the organ in the system 3000. As the fluid flows through the system and passes through the at least one sensor array 3350, 3351 the sensors within will monitor the fluid for variables. Variables may include, but are not limited to, flow, pressure, oxygen concentration, pressure, and color. These variables are used to regulate the flow of the fluid and monitor the health of the organ. Placing the at least one sensor array 3350, 3351 before and after entry into the organ donor allows for multiple sets of data to be compared to further monitor the health of the organ.

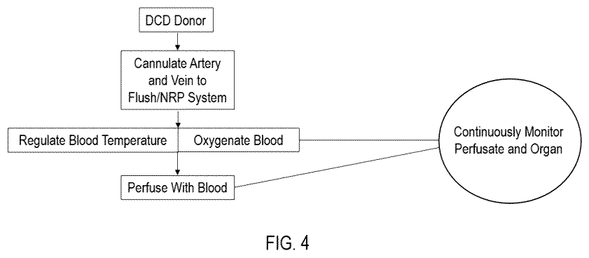

Now referring to FIG. 4, which depicts a method of simultaneously perfusing an organ donor with blood and monitoring the organ donor's organs. When an organ donor experiences circulatory death (DCD) along with meeting the other requirements for the procurement of an organ donor's organs, the process may begin. Because this process is not immediate and an organ donor's organs typically are not being retrieved and transported by the same medical teams it is important to increase the life of an organ before it is transplanted. This method begins when an organ donor experiences DCD and meets the requirements for organ procurement. The organ donor will be cannulated at two sites, an artery and a vein, while an aortic clamp is placed below the diaphragm. These cannulation sites are used to connect the organ donor to the system described in FIGS. 1-3. The fluid reservoir of the system is filled with blood, the blood is temperature regulated and oxygenated, and then perfused through the organ donor. While this perfusion occurs the blood is being monitored, as are the organ of the organ donor to ensure that the organs are remaining healthy so that they may have the best chances at a successful transplant.

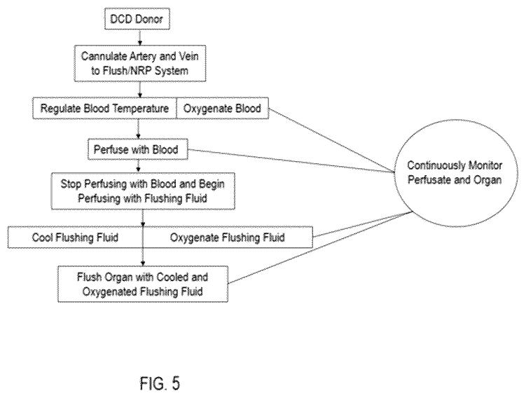

Now referring to FIG. 5, which depicts a method of simultaneously perfusing an organ donor with fluid and monitoring the organ donor's organs. When an organ donor experiences circulatory death (DCD) along with meeting the other requirements for the procurement of an organ donor's organs, the process may begin. Because this process is not immediate and an organ donor's organs typically are not being retrieved and transported by the same medical teams it is important to increase the life of an organ before it is transplanted. This method begins when an organ donor experiences DCD and meets the requirements for organ procurement. The organ donor will be cannulated at two sites, an artery and a vein, while an aortic clamp is placed below the diaphragm. These cannulation sites are used to connect the organ donor to the system described in FIGS. 1-3. The fluid reservoir of the system is filled with blood, the blood is temperature regulated and oxygenated, and then perfused through the organ donor. While this perfusion occurs the blood is being monitored, as are the organ of the organ donor to ensure that the organs are remaining healthy. Because organs are not typically transported warm and filled with blood, the method may involve lowering the temperature of the blood to lower the temperature of the organ. Then the fluid may be switched from blood to flushing fluid. The flushing fluid may then be perfused through the organ donor in the same manner in which the blood is perfused through the organ donor. Including, but not limited to, cooling the flushing fluid and oxygenating the flushing fluid. While the flushing fluid is perfused, the organs and flushing fluid are continuously monitored to monitor organ health and status. Perfusing the organs with cooled and oxygenated flushing fluid lowers the temperature and metabolic activity of the organs while also flushing them of blood and metabolites to prepare them for retrieval and transport.

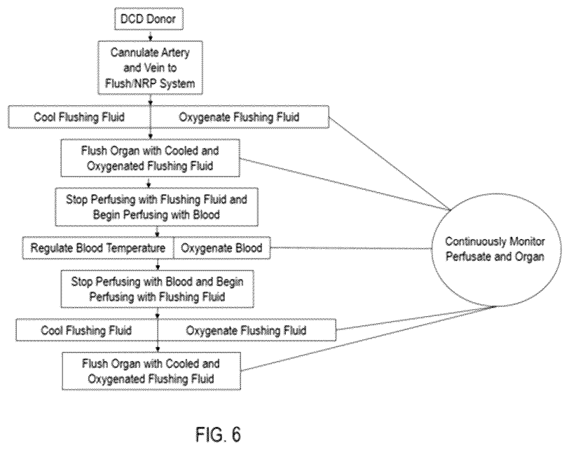

Now referring to FIG. 6, which depicts a method of simultaneously perfusing an organ donor with fluid and monitoring the donor organs. When an organ donor experiences circulatory death (DCD) along with meeting the other requirements for the procurement of donor organs, the process may begin. Because this process is not immediate and donor organs typically are not being retrieved and transported by the same medical teams it is important to increase the life of an organ before it is transplanted. This method begins when an organ donor experiences DCD and meets the requirements for organ procurement. The organ donor will be cannulated at two sites, an artery and a vein, while an aortic clamp is placed below the diaphragm. These cannulation sites are used to connect the organ donor to the system described in FIGS. 1-3. The fluid reservoir of the system is filled with flushing fluid, the flushing fluid is temperature regulated and oxygenated, and then perfused through the organ donor. While this perfusion occurs the flushing fluid is being monitored, as are the organ of the organ donor to ensure that the organs are remaining healthy. Then the fluid may be switched from flushing fluid to blood. The blood is temperature regulated and oxygenated, and then perfused through the organ donor. While this perfusion occurs the blood is being monitored, as are the organ of the organ donor to ensure that the organs are remaining healthy. Because organs are not typically transported warm and filled with blood, the method may involve lowering the temperature of the blood to lower the temperature of the organ. Then the fluid may be switched from blood to flushing fluid. The flushing fluid may then be perfused through the organ donor in the same manner in which the blood is perfused through the organ donor. Including, but not limited to, cooling the flushing fluid and oxygenating the flushing fluid. While the flushing fluid is perfused, the organs and flushing fluid are continuously monitored to monitor organ health and status. Perfusing the organs with cooled and oxygenated flushing fluid lowers the temperature and metabolic activity of the organs while also flushing them of blood and metabolites to prepare them for retrieval and transport.

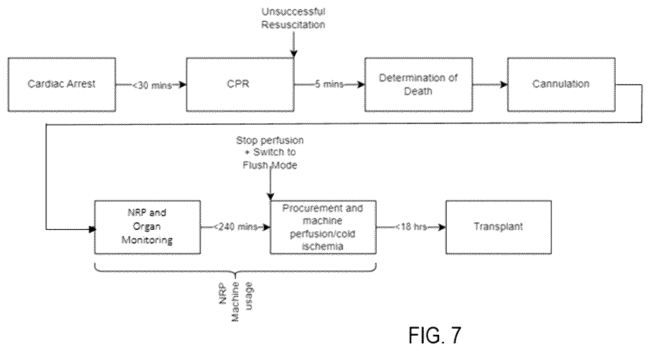

Now referring to FIG. 7, which depicts a method of perfusing and monitoring organs for transplant. FIG. 7 incorporates accepted aspects of NRP used in the medical community. The process begins when a patient's heart stops beating (and if the patient is a registered organ donor, or has otherwise agreed to donate their organs). After the patient's heart stops beating, the medical team performs CPR for approximately 30 minutes, which if unsuccessful leads to a 5-minute waiting period until the patient is considered to be deceased by circulatory death (DCD). At this point the medical team may begin the systems and methods described in FIGS. 1-6. The patient, now organ donor may be cannulated. Two points are cannulated, an artery and a vein, the pair of which, for example, but not limited to the example, may be the femoral artery and femoral vein. Depending on if the procedure is A-NRP or TA-NRP, the clamping position differs. In A-NRP, an aortic clamp is placed below the diaphragm to prevent reperfusion of the heart and brain. In TA-NRP, a balloon catheter is typically used to prevent blood flow to the brain. The cannulated artery and vein may be connected to the system described in FIGS. 1-3, to begin organ perfusion and monitoring. At this point blood may be perfused through the organs while being temperature regulated and oxygenated. The perfusate and organs are also monitored by at least one sensor array to ensure organ function and health are satisfactory for transplant. This perfusion may carry on for up to four hours. At this point the blood may be replaced with a flushing fluid, and a flush of the organs may occur. For an organ flush, the flushing fluid is cooled and flushed through the organs to flush the organs of any buildup and lower the temperature and metabolic activity of the organs. Then the organs may be retrieved and subsequently transported and transplanted.

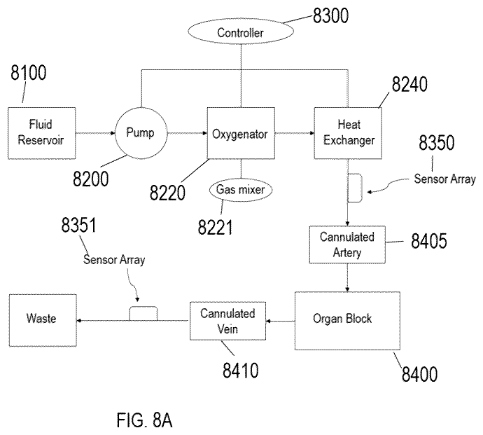

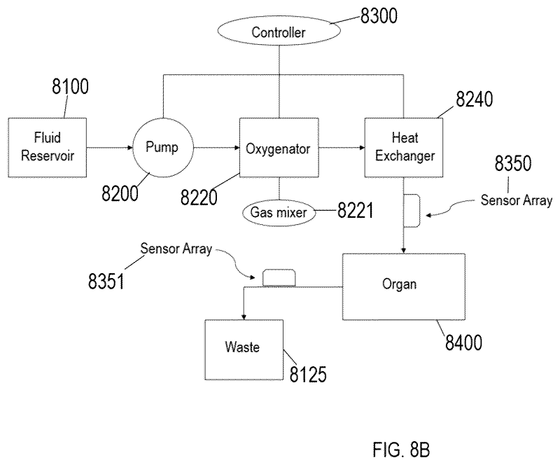

Referring now to FIGS. 8A-8B, which depict system of a controlled flush of organs as an organ block or individually. The system 8000 generally includes a fluid reservoir 8100, a pump 8200, an oxygenator 8220, a heat exchanger 8240, at least one controller 8300, at least one sensor array 8350, and a waste receptacle 8125. The system involves a pump 8200 that pumps fluid from a fluid reservoir 8100 through the elements of the system. The fluid being pumped through the system 8000 is a preservation solution. The flushing fluid may be, for example but not limited to, saline, saline based solutions, albumin based solutions, preservation solution, crystalloid solutions, colloid solutions, or lactated ringer solution. The preservation solution may be any of the accepted preservation solutions used by the medical field in the processes of organ preservation, for example but not limited to, UW solution, and HTK solution. When pumping flushing fluid through the system 8000 certain nutrients may be added to the solution, nutrients may be for example, but not limited to, glucose. The flushing fluid is pumped through the system 8000 and emptied into a waste receptacle 8125. Flushing fluid may be oxygenated by the oxygenator 8220. Preservation may be cooled by the heat exchanger 8240. The oxygenated and/or cooled flushing fluid is pumped through the system to flush the organs in the organ block of any blood or buildup.

Referring specifically to FIG. 8A, in an aspect, the pump 8200 pumps fluid from the fluid reservoir 8100, through the oxygenator 8220, through the heat exchanger 8240, through a cannulated artery 8405, through an organ 8400, and through a cannulated vein 8410. The system 8000 is generally used on an organ donor, where the donor organs are being prepped for removal and transport. Fluid is pumped through the system through a fluid line and is oxygenated by the oxygenator 8220, and thermally regulated by the heat exchanger 8240. The fluid line is representative of the connection between certain elements of the system 8000 to allow fluid to flow through the system 8000. In an aspect, the fluid reservoir is fluidly connected to the pump 8200. In an aspect, the pump 8200 is fluidly connected to the oxygenator 8220. In an aspect, the oxygenator 8220 is fluidly connected to the heat exchanger 8240. In an aspect, the heat exchanger 8240 is fluidly connected to the cannulated artery 8405. In an aspect, the cannulated vein 8410 is fluidly connected to the waste receptacle 8125. Any one element of the system 8000 may be fluidly connected to any other element of the system 8000 in any order and any combination.

Referring specifically to FIG. 8B, this system does not include the cannulation of the artery and vein of the organ donor. Rather the system is connected directly into the organ itself, so that the fluid is pumped directly through the system then through the organ.

Referring generally to FIGS. 8A-B, the at least one sensor array may include but is not limited to including; a flow sensor, a temperature sensor, an oxygen sensor, a pressure sensor, and a color sensor. The at least one sensor array 8350 may comprise any combination and any order of the aforementioned sensors and any additional sensors not included. The at least one sensor array 8350 may be placed on any point along the fluid line of the system 8000. A flow sensor is used to monitor the flow of the fluid at any point in the system 8000. A temperature sensor is used to monitor the temperature of the fluid at any point in the system 8000. A temperature sensor is used to monitor the temperature of the organ in the system 8000. An oxygen sensor is used to monitor the oxygen levels of the fluid at any point in the system 8000. A pressure sensor is used to monitor the pressure of the fluid flow at any point in the system 8000. A color sensor is used to monitor the color of the organ in the system 8000. In an aspect, the at least one sensor array 8350 is positioned along the fluid line at a point prior to the fluid's entry into the cannulated artery 8405. In an aspect, the at least one sensor array 8350 is positioned along the fluid line at a point after the fluid's exiting of the cannulated vein 8410. In an aspect, the at least one sensor array 8350 is communicatively coupled to the at least one controller 8300. In an aspect, the information gathered by the at least one sensor array 8350 is passed to the at least one controller 8300. In an aspect, the information passed to the at least one controller 8300 is used to modify instructions from the at least one controller 8300.

Still referring to FIG. 8A-B, the at least one controller 8300 may be for example, but not limited to, a thermal controller, a flow controller, an oxygenation controller, and a pressure controller. One of the at least one controllers 8300 is communicatively coupled to the pump 8200 to facilitate the pumping of the fluid. One of the least one controllers 8300 is communicatively coupled to the oxygenator 8220 and gas mixer 8221 to facilitate oxygenation of the fluid. The gas mixer provides at least one type of gas to the oxygenator, types of gases may include but are not limited to including; oxygen. One of the at least one controllers 8300 is communicatively coupled to the heat exchanger 8240 to facilitate thermal regulation of the fluid. One of the at least one controllers 8300 is communicatively coupled to the pump 8200 to facilitate the flow of the fluid. The at least one controllers 8300 and at least one sensor array 8350 allows for a controlled flush of the organ, where the organ may be monitored.

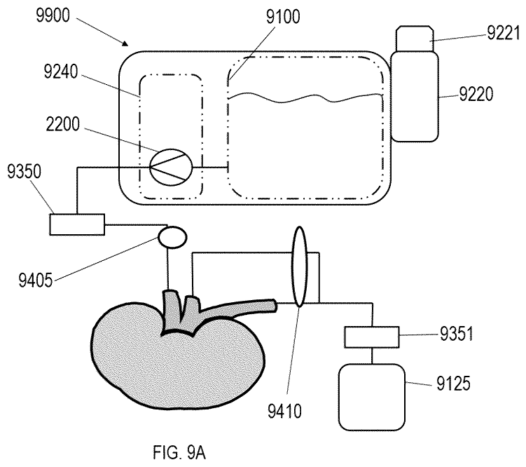

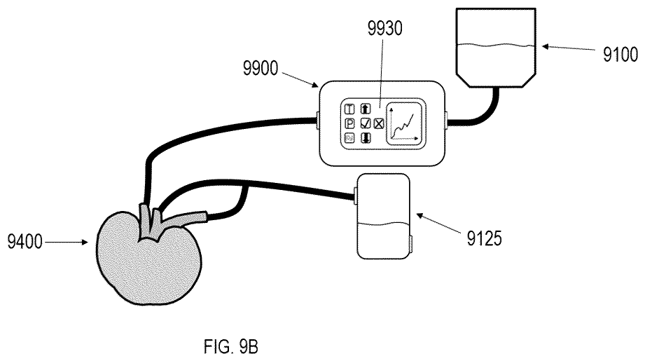

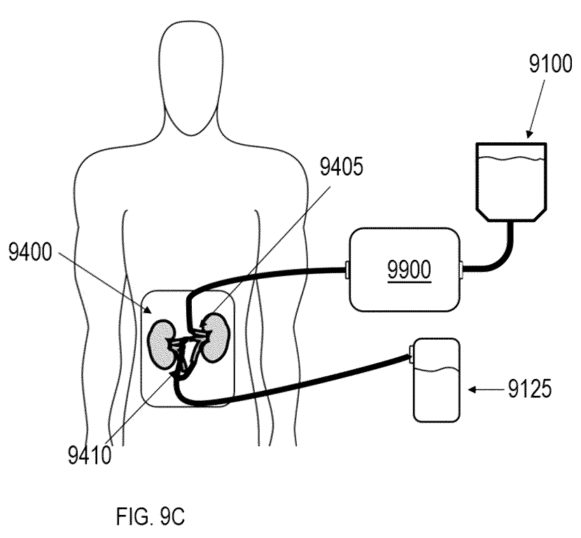

Referring now to FIG. 9A-9C, which depicts a system for pumping fluid through an organ, specifically a kidney, and the elements of the system 9000 being set in a housing 9900. The system 9000 generally includes a fluid reservoir 9100, a pump 9200, an oxygenator 9220, a heat exchanger 9240, at least one controller, at least one sensor array 9350, and a waste receptacle 9125. As a part of the system 9000, the renal artery 9405 and renal vein 9410 are cannulated, when the tissue is any organ other than the kidney, the appropriate artery and vein of the organ are then cannulated. These cannulations allow the system 9000 to perfuse flushing fluid 8104 through the kidney 9400. For example, cold flushing fluid is pumped through the kidney to flush the kidney of blood and any other buildup while also cooling the organ for transport.

Still referring to FIG. 9A-9C, as organs are ready to be retrieved, they are not typically transported full of blood. The process typically involves lowering the temperature of the organs and flushing them. In the system 9000, flushing fluid 8104 may be cooled to lower the temperature of the organ and decrease its metabolic activity, to flush the organ of blood and metabolites whiles also lowering the temperature and metabolic activity of the kidney 9400.

Continuing to refer to FIG. 9A-9C, flushing fluid 8104 in the system 9000 is pumped from the fluid reservoir 9100 by a pump 9200 and subsequently pumped through an oxygenator 9220 which oxygenates the flushing fluid 9104 and a heat exchanger 9240 which cools the flushing fluid 9104. The now cooled and oxygenated flushing fluid 9104 is pumped through an organ, which may be a kidney 9400. The cooled and oxygenated flushing fluid 9104 pumps through the organ and out into a waste receptacle.

Continuing to refer to FIG. 9A-9C, the at least one sensor array 9350 can be placed anywhere along the system 9000. In one embodiment one of the at least one sensor arrays 9350 is placed on the fluid line just prior to the flushing fluids 9104 entry into the kidney 9400 and another one of the at least one sensor arrays 9350 is placed at a point on the fluid line just after the flushing fluid 9104 exits the kidney and before it enters the waste receptacle 9125. This embodiment allows for the flushing fluid 9104 to be monitored before and after it passes through the kidney 9400, which gives indications to the state of the kidney 9400 and the functioning of the system 9000. A sensor array may also be placed in connection with the kidney 9400 to monitor the health of the organ itself.

Still referring to FIG. 9A-9C, the at least one sensor array 9350, 9351 may include but is not limited to including; a flow sensor, a temperature sensor, an oxygen sensor, a pressure sensor, and a color sensor. The at least one sensor array 9350, 9351 may comprise any combination and any order of the aforementioned sensors and any additional sensors not included. The at least one sensor array 9350 may be placed on any point along the fluid line of the system 9000. A flow sensor is used to monitor the flow of the fluid at any point in the system 9000. A temperature sensor is used to monitor the temperature of the fluid at any point in the system 9000. A temperature sensor is used to monitor the temperature of the organ in the system 9000. An oxygen sensor is used to monitor the oxygen levels of the fluid at any point in the system 9000. A pressure sensor is used to monitor the pressure of the fluid flow at any point in the system 9000. A color sensor is used to monitor the color of the organ in the system 9000. As the flushing fluid 9104 flows through the system and passes through the at least one sensor array 9350, 9351 the sensors within will monitor the fluid for variables. Variables may include, but are not limited to, flow, pressure, oxygen concentration, pressure, and color. These variables are used to regulate the flow of the flushing fluid 9104 and monitor the health of the organ. Placing the at least one sensor array 9350, 9351 before and after entry into the organ donor allows for multiple sets of data to be compared to further monitor the health of the organ.

Continuing to refer to FIGS. 9A-9C, certain elements of the system 9000, for example, but not limited to, the oxygenator 9220, the fluid reservoir 9100, the pump 9200, and the heat exchanger 9240 may be set in a housing 9900. The elements may be interconnected and placed within a larger housing to make the system 9000 more mobile and easier to move around and use in a medical setting. For example, having some or all of the elements of the system 9000 in a housing 9900 makes it so the system 9000 can be quickly and easily transported into operating rooms as necessary. The housing 9900 will keep the elements together and take up less room in an OR.

Referring specifically to FIG. 9B, which depicts the system for flushing an organ having a UI 9930. The UI 9930 may be communicatively coupled with the at least one controller to visualize the data gathered by the at least one sensor array 9350. The UI 9930 may be communicatively coupled with the at least one controller to have a method of interacting with and sending instructions to the at least one controller. Such instructions may be for example, but not limited to, changing the temperature of the fluid, changing the flow rate, and changing the oxygen concentration. The UI 9930 may be communicatively coupled with the at least one controller to visualize data related to organ health and function.

Referring specifically to FIG. 9C, which depicts the system for flushing an organ, flushing an organ in situ. The system 9000 may not always be connected to an organ that is removed from the donor's body. As seen in FIG. 9C the system 9000 may be cannulated to an organ in situ and flushed before being removed from the donor's body.

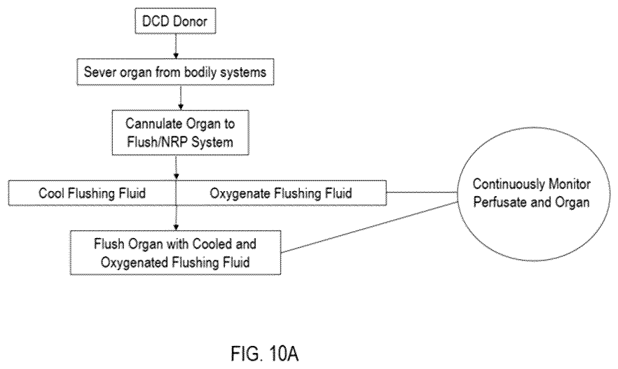

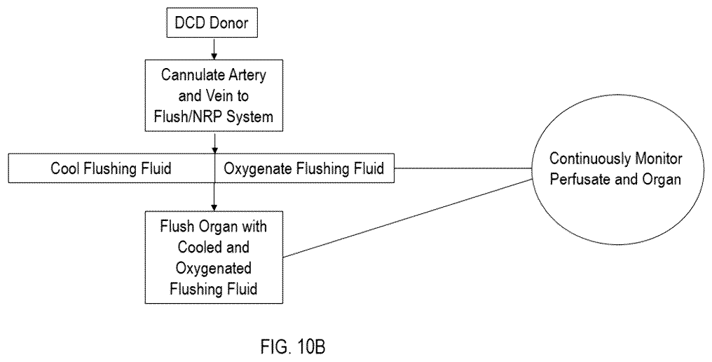

Referring now to FIGS. 10A-10B, which depicts a method of pumping fluid through an organ. When an organ donor experiences circulatory death (DCD) along with meeting the other requirements for the procurement of donor organs, the process may begin. Flushing an organ with flushing fluid will increase the survivability of an organ which is to be transported for transplant. This method begins when an organ donor experiences DCD and meets the requirements for organ procurement. Referring specifically to FIG. 10A, the organs will be severed from the relevant bodily systems, then cannulated to the flush system. Then a flushing fluid will be cooled and oxygenated to be flushed through the organ. Throughout the flush, the flow is being monitored as is the organ, to monitor the health of the organ and function of the flow.

Referring specifically to FIG. 10B, after the donor experiences DCD, the organs will not be removed from the body as shown in FIG. 10A, but rather left in the body. The artery and vein of the organ will then be cannulated to the flush system. After cannulation, flushing fluid that is cooled and oxygenated will be flushed through the organ. Throughout the flush, the flow is being monitored as is the organ, to monitor the health of the organ and function of the flow.

What is claimed is:

1. A system for perfusing transplantable organs located within a human body, the system comprising:
at least one reservoir;
at least one pump fluidly connected to the reservoir;
one of the at least one pumps having:
an oxygenator;
a gas mixer coupled to said oxygenator;
a heat exchanger;
a waste container;
a plurality of tubing fluidically connecting said at least one reservoir, said at least one pump, and said waste container to one another and to at least one blood vessel;
at least one sensor array;
at least one controller;
the at least one controller initiating a first perfusion stage, the first perfusion stage having a first fluid;
the at least one controller transitioning from the first perfusion stage to a second perfusion stage, the second perfusion having a second fluid.

2. The system of claim 1, wherein the first fluid is selected from the group consisting of: blood, flushing fluid, and combinations thereof.

3. The system of claim 2, wherein the flushing fluid is selected from the group consisting of: saline, saline based solutions, albumin based solutions, preservation solution, crystalloid solutions, colloid solutions, lactated ringer solution, and combinations thereof.

4. The system of claim 2, wherein the at least one controller controls oxygenation of the first fluid.

5. The system of claim 2, wherein the at least one controller controls a temperature of the first fluid.

6. The system of claim 5, wherein during the first perfusion stage the controller lowers the temperature of the first fluid before transitioning from the first perfusion stage to the second perfusion stage.

7. The system of claim 6, wherein the first fluid is cooled to a temperature above 0 degrees Celsius but below 10 degrees Celsius.

8. The system of claim 6, wherein the first fluid is cooled towards an end stage of the first perfusion stage.

9. The system of claim 1, wherein the second fluid is selected from the group consisting of: flushing fluid, blood, and combinations thereof.

10. The system of claim 9, wherein the flushing fluid is selected from the group consisting of: saline, saline based solutions, albumin based solutions, preservation solution, crystalloid solutions, colloid solutions, lactated ringer solution, and combinations thereof.

11. The system of claim 9, wherein the at least one controller controls oxygenation of the second fluid.

12. The system of claim 9, wherein the at least one controller controls a temperature of the second fluid.

13. The system of claim 12, wherein the at least one controller lowers the temperature of the second fluid to a temperature above 0 degrees Celsius but below 10 degrees Celsius.

14. The system of claim 1, wherein the at least one controller monitors a flow of the first fluid.

15. The system of claim 1, wherein the at least one controller monitors a flow of the second fluid.

16. The system of claim 1, wherein the at least one controller monitors a status of the organ.

17. The system of claim 1, wherein one of the at least one reservoirs is configured to contain the first fluid, and another one of the at least one reservoirs is configured to contain the second fluid.

18. The system of claim 17, wherein the first fluid stops flowing from one of the at least one reservoirs at an end of the first perfusion stage, and the second fluid begins to flow from another one of the at least one reservoirs at a beginning of the second perfusion stage.

19. The system of claim 1, wherein one of the at least one blood vessels is an artery;

20. The system of claim 19, wherein the artery is a femoral artery;

21. The system of claim 1, wherein one of the at least one blood vessels is a vein;

22. The system of claim 21, wherein the vein is a femoral vein;

23. The system of claim 1, wherein the gas mixer is configured to provide at least one gas to the oxygenator, the at least one gas is selected from the group consisting of: oxygen, nitrogen, carbon dioxide and combinations thereof.

24. The system of claim 1, wherein the at least one sensor array is located between the pump and the at least one blood vessel.

25. The system of claim 1, wherein the at least one sensor array is located between the at least one blood vessel and the waste container.

26. The system of claim 1, wherein the at least one sensor array includes a plurality of sensors, the plurality of sensors is selected from the group consisting of: flow sensor, temperature sensor, pressure sensor, oxygen sensor, color sensor, and combinations thereof.

27. The system of claim 1, wherein the at least one controller includes a thermal controller.

28. The system of claim 1, wherein the at least one controller includes a flow controller.

29. The system of claim 1, further comprising a control panel communicatively coupled with the plurality of controllers, the control panel is communicatively coupled with the plurality of sensors.

30. The system of claim 29, wherein the control panel further comprises a user interface, where a user can interact with to program the plurality of controllers and view the information gathered by the plurality of sensors.

31. The system of claim 1, wherein one of the at least one pumps is an infusion pump.

32. The system of claim 31, wherein the infusion pump is configured to provide at least one nutrient to the at least one fluid, the at least one nutrient is selected from the group consisting of: glucose, anticoagulants, antibiotics, vasodilators, and combinations thereof.

33. A method for perfusing transplantable organs located within a human body, the method comprising:
fluidly connecting a first reservoir maintaining a first fluid to a pump;
fluidly connecting the pump to at least one blood vessel;
oxygenating the fluid;
regulating a temperature of the fluid; and
beginning a first perfusion stage, pumping the first fluid through one of the least one blood vessels and out another one of the at least one blood vessels;
monitoring the fluid with at least one sensor array;
monitoring at least one organ with the at least one sensor array;
transitioning to a second perfusion stage, connecting a second reservoir maintaining a second fluid to the pump and pumping the second fluid; and
cooling the temperature of the second fluid.

34. The method of claim 33, wherein the first fluid is blood.

35. The method of claim 33, wherein the second fluid is flushing fluid.

36. The method of claim 35, wherein the flushing fluid is selected from the group consisting of: saline, saline based solutions, albumin based solutions, preservation solution, crystalloid solutions, colloid solutions, lactated ringer solution, and combinations thereof.

37. The method of claim 33, wherein a controller lowers the temperature of the first fluid and the second fluid.

38. The method of claim 33, wherein a controller controls the oxygenation of the first fluid and the second fluid.

39. The method of claim 36, wherein the flushing fluid is regulated at a temperature of between 0-10° C.

40. The system of claim 1, wherein the at least one sensor array includes a plurality of sensors, the plurality of sensors is selected from the group consisting of: flow sensor, temperature sensor, pressure sensor, oxygen sensor, color sensor, and combinations thereof.

41. A system for perfusing transplantable organs, the system comprising:
a reservoir configured to contain flushing fluid;
a pump fluidly connected to the reservoir;
the pump having:
an oxygenator;
a gas mixer coupled to said oxygenator;
a heat exchanger;
a waste container;
a plurality of tubing fluidically connecting said reservoir, said pump, and said waste container to one another and to an organ artery, and an organ vein;
at least one sensor array;
at least one controller; and
a cold flush stage wherein flushing fluid is cooled and pumped through the organ artery.

42. The system of claim 41, wherein the flushing fluid is selected from the group consisting of: saline, saline based solutions, albumin based solutions, preservation solution, crystalloid solutions, colloid solutions, lactated ringer solution, and combinations thereof.

43. The system of claim 41, wherein the controller lowers a temperature of the flushing fluid.

44. The system of 43, wherein the flushing fluid is lowered to a temperature above 0 degrees Celsius but below 10 degrees Celsius.

45. The system of claim 41, wherein the controller monitors a status of an organ connected to the system.

46. The system of claim 41, wherein the controller monitors a flow of the fluid.

47. The system of claim 41, wherein the first fluid stops flowing from one of the at least one reservoirs at an end of the first perfusion stage, and the second fluid begins to flow from another one of the at least one reservoirs at a beginning of the second perfusion stage.
